(19) United States
(12) Patent Application Publication
(10) Pub. No.: US 2015/0106736 A1
(43) Pub. Date: Apr. 16, 2015

(54) ROLE-BASED PRESENTATION OF USER INTERFACE

(71) Applicant: salesforce.com, inc., San Francisco, CA (US)

(72) Inventors: Adam Torman, Oakland, CA (US); Jimmy Hua, San Francisco, CA (US); John Arlan Brock, San Francisco, CA (US); Anjesh Dubey, Union City, CA (US)

(21) Appl. No.: 14/502,793

(22) Filed: Sep. 30, 2014

Related U.S. Application Data
(60) Provisional application No. 61/891,169, filed on Oct. 15, 2013.

(51) Int. Cl. H04L 29/08; G06F 17/30; G06F 3/0484

(52) U.S. Cl. CPC H04L 67/306; G06F 3/04842; G06F 17/30943; G06F 17/30091; G06F 17/30126
USPC 715/745

(57) ABSTRACT

Disclosed are some examples of systems, apparatus, methods and storage media for configuring the presentation of a user interface (UI) based on a role of the user with respect to a data object. In some implementations, a database system stores a plurality of data objects and user profiles. The system further includes processors operable to receive a first request for a data object from a user device, identify available UI configurations based on the user profile and on the data object, communicate first information to the user device for displaying a UI having a first one of the available UI configurations, receive a second request to change the UI to have a second one of the available UI configurations, and communicate second information to the user device for displaying the second UI configuration.

### PRIORITY DATA

This patent document claims the benefit of priority under 35 U.S.C. 119(e) to U.S. Provisional Patent Application No. 61/891,169, titled SYSTEM AND METHOD FOR PERMISSIONS FOR LAYOUTS OF RECORDS BASED ON USER PROFILES, by Torman et al., filed on 15 Oct. 2013 (Attorney Docket No. 1312PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

This patent document relates generally to providing a user interface that enables a user to view or interact with a data object, and more specifically, to configuring the presentation of the user interface based on a role of the user with respect to the data object.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows an example of a group feed on a group profile page according to some implementations.

FIG. 4 shows an example of a record feed on a record profile page according to some implementations.

FIG. 5 shows a representation of an example of a layered data object according to some implementations.

FIG. 6 shows an example of a UI for an account record according to some implementations.

FIG. 7 shows a different example of a UI for the account record of FIG. 6 according to some implementations.

FIG. 8 shows the UI of FIG. 6 with an expanded view of a page layout picklist displayed after the selection of a Switch View UI element according to some implementations.

FIG. 9 shows a timing diagram illustrating an example of a computer-implemented process flow for providing a UI for display to a user according to some implementations.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for providing a user interface that enables a user to view or interact with a data object, and more specifically, to configuring the presentation of the user interface based on a role of the user with respect to the data object. In some implementations, responsive to receiving a first request for a data object, a system identifies one or more available user interface (UI) configurations based on the data object and a user profile of the user. The system then selects or generates a UI having a first one of the available UI configurations and provides the UI for transmission to the user. Subsequently, responsive to receiving a second request to change the UI to a second one of the available UI configurations, the system selects or generates a UI having the second one of the UI configurations and provides the UI for transmission to the user. In some implementations, the first UI configuration facilitates a first role of the user with respect to the data object while the second UI configuration facilitates a second role of the user with respect to the data object.

In some implementations, each user profile is associated with one or more sets of one or more permissions. In some such implementations, responsive to receiving the first request, the system accesses the user profile associated with the user and identifies the sets of permissions associated with the user profile. For example, the first UI configuration can be associated with a first permission set associated with the user profile while the second UI configuration can be associated with a second permission set associated with the user profile.

In some implementations, the system further identifies an object type of the requested data object. In some such implementations, one or more of the available user interface UI configurations are identified based on the object type and the one or more permission sets associated with the user profile. For example, the first UI configurations can be assigned a first layout based on the object type and the first permission set while the second UI configuration can be assigned a second layout based on the object type and the second permission set.

In some implementations, responsive to receiving the second request, the system determines whether the user is authorized to view the second one of the UI configurations based on the identified sets of permissions associated with the user's user profile, for example, by determining whether the user profile is associated with the second permission set. Additionally, in some implementations, the second request to change the UI to the second one of the available UI configurations can be originated responsive to the user selecting a UI element from the first one of the UI configurations.

By way of context, administrators can have the ability to assign a single page layout to a data object (for example, a record) for display to a user based on the user's user profile. This can ensure that every time a user requests to view a record stored in a database, there is always one layout to display the record's information to the user. However, there are use cases when an administrator needs to assign multiple layouts to a user, such as in a positive and additive fashion. For example, a temporary assignment may occur during which the user must temporarily cover for the user's supervisor, thus requiring an additional or expanded layout. As another example, the user may have more than one role, task or process associated with the same record. As another example, more than one user application may share the same record, such as when a sales application and a service application share the same account records for different purposes. In some implementations, an administrator can assign multiple layouts to a user through the use of permission sets associated with the user's profile.

In one example use case, a database system receives a request to view a record. For example, the request can originate from an account executive requesting to view the records for a customer, “Acme Corporation.” The database system provides a user interface (UI) having a first layout for the record for display to the account executive based on a set of permissions associated with the user profile of the account executive. For example, the database system can provide a sales layout for the Acme Corporation because the default layout for the account executive's user profile is assigned the sales layout. Viewing the sales layout of the Acme Corporation enables the account executive to view sales-related records, change sales information, and take sales action with respect to the Acme Corporation account.

The database system can receive a request to change the first layout of the record to a second layout of the record. For example, the account executive may receive an urgent phone call from an Acme Corporation employee about a service problem. In such an instance, much of the sales information displayed in the UI for the account is no longer relevant to the user's current role and current needs. The account executive needs or desires a different layout of the Acme Corporation records that contains the relevant information and controls associated with facilitating a services role. The database system can determine whether the user profile is associated with a permission to change the first layout of the record to the second layout of the record. For example, the database system can display a “switch view” button, toggle switch, menu or picklist to the account executive from which the account executive can select or otherwise request a preferred layout of the record from a list or subset of the page layouts authorized for display to the user for that record. For example, a picklist can display a sales layout option and a service layout option to the account executive because the account executive's user profile is associated with both a sales permission or set of permissions as well as a service permission or set of permissions for that record or record type.

When the account executive selects the service layout option, the database system provides the service layout of the Acme Corporation records. Viewing the service layout of the Acme Corporation records enables the account executive to view service related records, such as a service level agreement, change service information, and take service action with respect to the Acme Corporation account. After the account executive addresses Acme Corporation's service emergency, the account executive can select the sales layout option, and the database system can subsequently provide the sales layout of the Acme Corporation records once again, which enables the account executive to complete his original sale-related task or to otherwise fulfill his sales-related role.

In this way, in some implementations, the database system can enable an end-user to resolve conflicts regarding which of the available layouts to provide for display to a user for a particular record or record type. That is, in some implementations, the database system can determine an initial or default layout for a record based on a user profile, while one or more alternative layouts made available by one or more different respective sets of permissions associated with the user's profile can be selected at runtime by the user for display instead of the default layout.

In some implementations, the users described herein are users (or “members”) of an interactive online “enterprise social network,” also referred to herein as an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

### I. Example System Overview

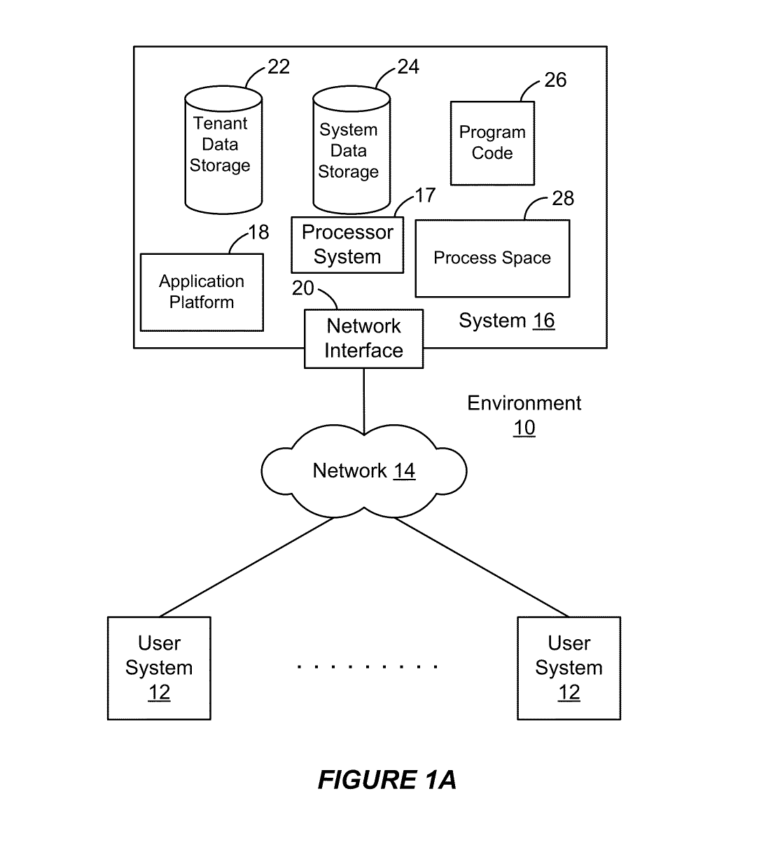

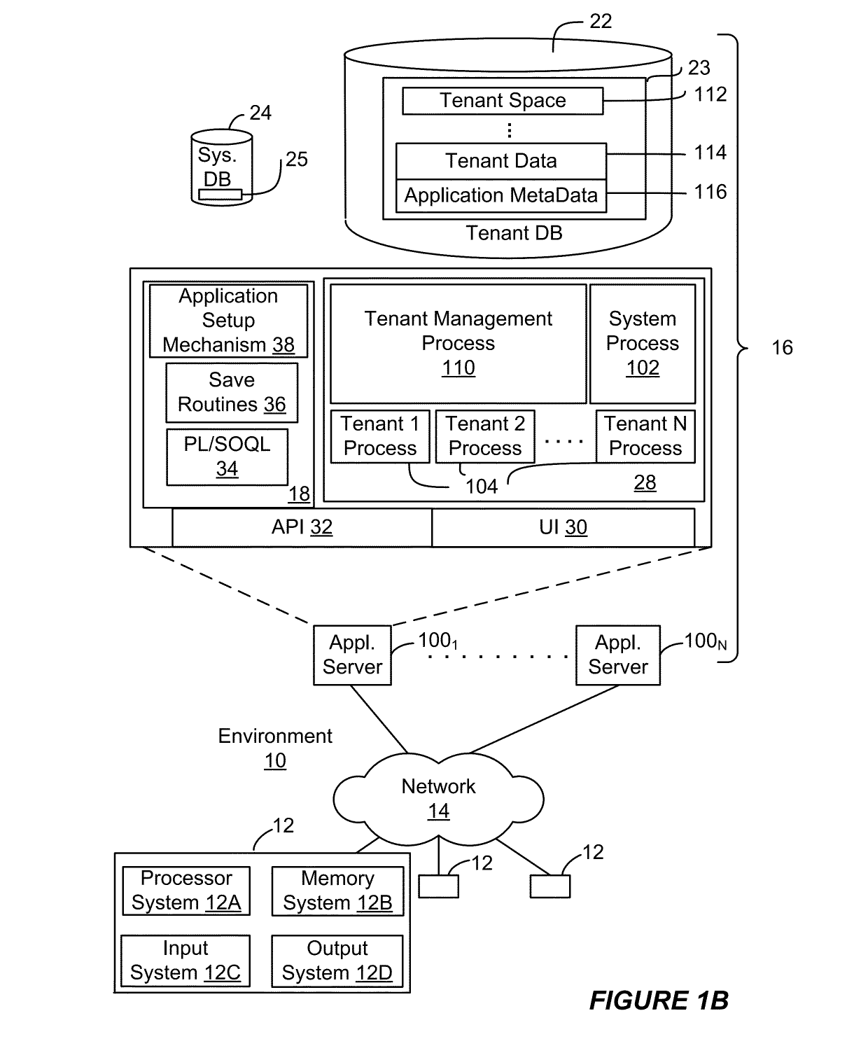

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application (or “app”) servers 100₁-100_{N}. Each of the application servers 100₁-100_{N} (also referred to collectively herein as “the application server 100”) is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

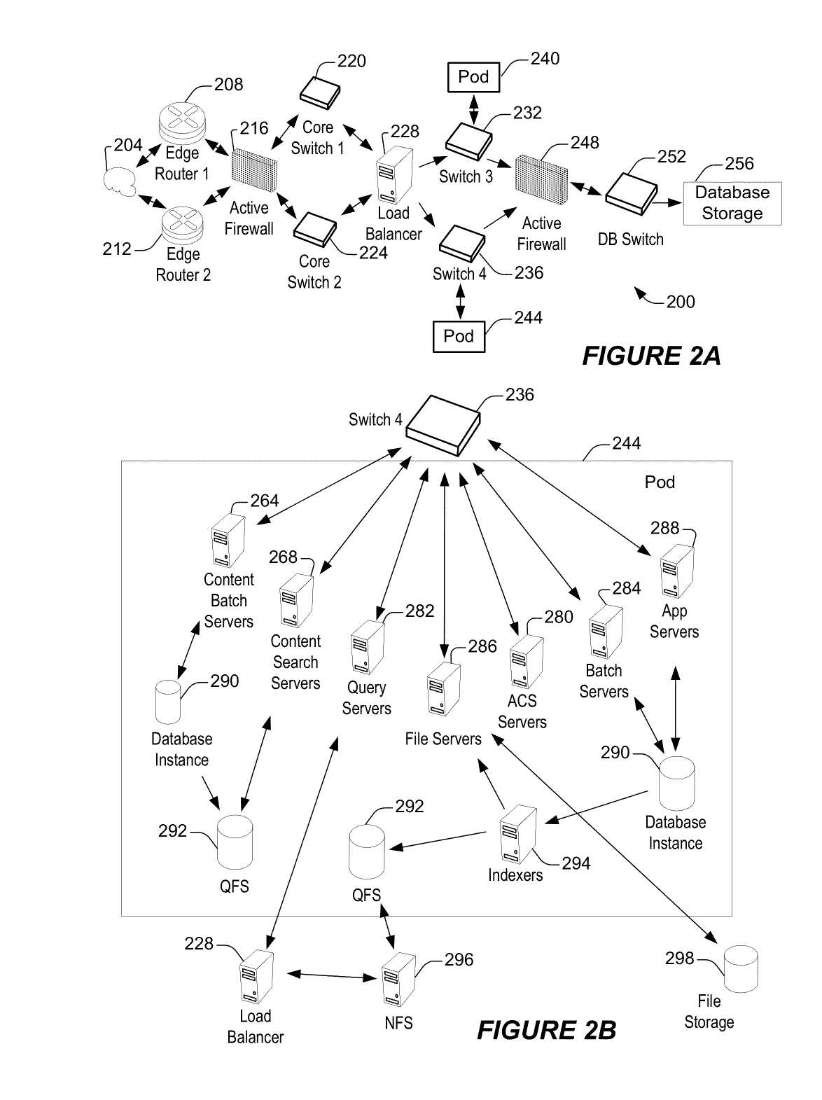

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

### II. Enterprise Social Networking

As initially described above, in some implementations, some of the methods, processes, devices and systems described herein can implement, or be used in the context of, enterprise social networking. Some online enterprise social networks can be implemented in various settings, including businesses, organizations and other enterprises (all of which are used interchangeably herein). For instance, an online enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). The data associated with a user profile also can include various permissions defining the ability of the user to interact with various data objects. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or a group of users of the database system 16. Such records can include, for example, data objects representing and maintaining data for accounts (for example, representing a business relationship with another enterprise). In some implementations, each record is assigned a record type, which can be identified by a RecordTypeID. Examples of account record types include: customers (for example, users or organizations who pay the enterprise money), customer support (for example, users or organizations who pay the enterprise money to support them), households (for example, organizations in a business-to-consumer model), partners (for example, organizations who pay the enterprise money and to whom the enterprise pays money), suppliers (for example, organizations to whom the enterprise pays money), and other organizations including organizations with whom no money is exchanged. Other examples of record types in addition to accounts can include cases, opportunities, leads, projects, contracts, orders, pricebooks, products, solutions, reports and forecasts, among other possibilities.

For example, an account record can be for a business partner or potential business partner, an actual or potential customer, an actual or potential supplier, an actual or potential distributor, or a client, among other possibilities. A record such as an account can include information describing an entire enterprise or subsidiary of an enterprise. As another example, a record such as an account record itself can include a number of records. For example, a customer account can include opportunities, contracts, and orders. As another example, a partner record can include a project or contract that a user or group of users is working on with an existing partner, or a project or contract that the user is trying to obtain with a partner. A record also can include various data fields and controls that are defined by the structure or layout of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages, files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed items object is a data structure that can be represented or conceptualized as a “Feed Items Table” that associates users, records and groups to posts, comments, documents or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

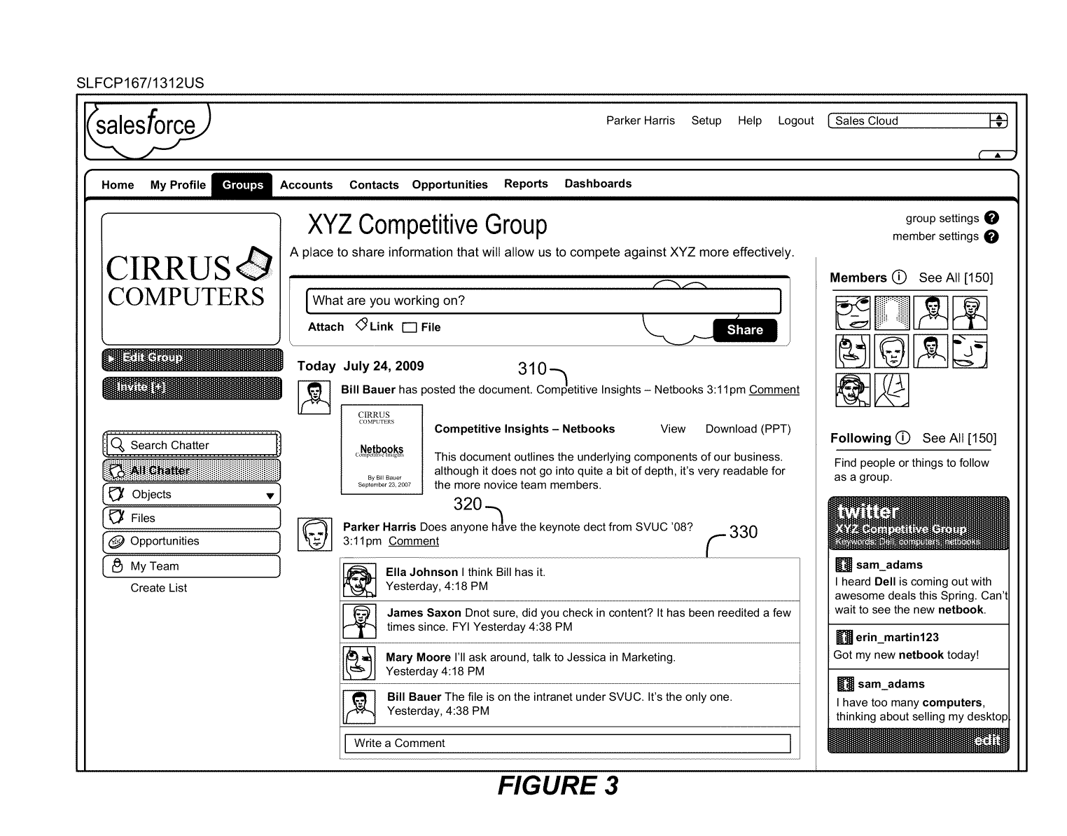

FIG. 3 shows an example of a group feed on a group profile page according to some implementations. As shown, a feed item 310 shows that a user has posted a document to the group feed. The text “Bill Bauer has posted the document Competitive Insights” can be generated by the database system in a similar manner as feed-tracked updates about a record being changed. A feed item 320 shows a post to the group, along with comments 330 from Ella Johnson, James Saxon, Mary Moore and Bill Bauer.

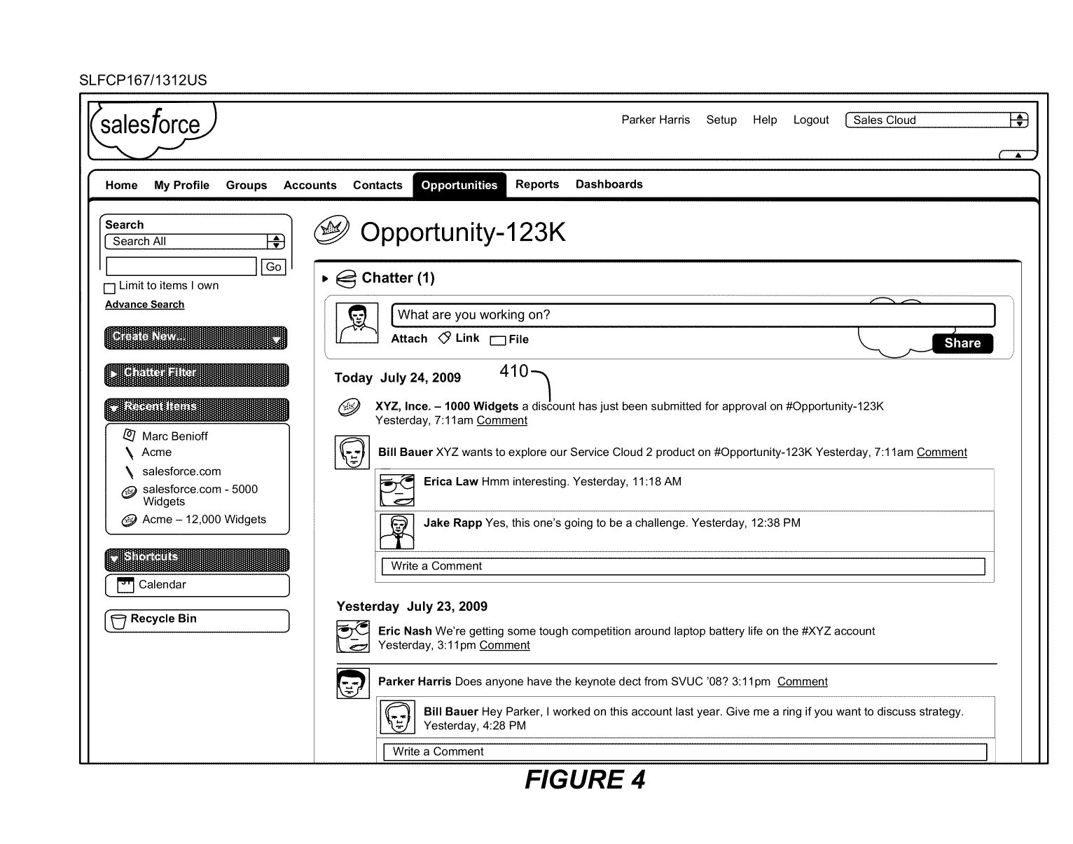

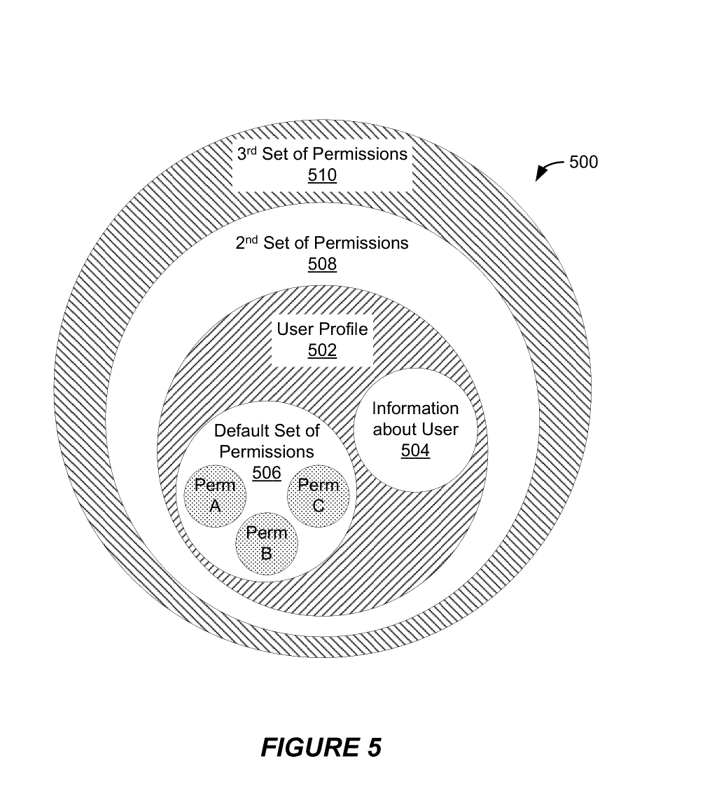

FIG. 4 shows an example of a record feed on a record profile page according to some implementations. The record feed includes a feed-tracked update, a post, and comments. Feed item 410 shows a feed-tracked update based on the event of submitting a discount for approval. Other feed items show posts, for example, from Bill Bauer, made to the record and comments, for example, from Erica Law and Jake Rapp, made on the posts.

### III. Role-Based Presentation of User Interface

Some implementations relate generally to providing a user interface (UI) that enables a user to access, view or interact with a data object. In some implementations, the UI can enable the user to access, view or interact with a record stored in the database system 16. For example, the application server 100 can provide the UI for transmission over one or more networks to a user's computing device for display to the user. Some implementations more specifically relate to configuring the presentation of the UI based on a relationship of the user with respect to the data object, for example, based on a role, sub-role, responsibility, task, or assignment of the user with respect to a record or record type, or based on a stage of the record.

In some implementations, the UI can be a web-based or “web” UI (WUI). Such a UI can be initially generated or selected by the database system 16 and transmitted as an electronic structured document for rendering by the user's computing device. The system can transmit the structured document via one or more wired or wireless networks or network connections to the user's computing device. A web browser or other client-side rendering application executing in the user's computing device renders the received renderable web document for display on the user's computing device as a rendered web UI. The database system 16 enables the user to interact with one or more applications or services provided by the system to access or modify information via the UI. In some implementations, the structured document generated by the system and transmitted to the user's computing device, as well as the web UI presented after rendering, can generally utilize or be constructed with, for example, one or more of Hypertext Markup Language (HTML), Extensible Markup Language (XML), Extensible HyperText Markup Language (XHTML), Java, JavaScript, asynchronous JavaScript and XML (AJAX), JavaScript Object Notation (JSON), Apache Flex, ActiveX, cascading style sheets (CSS), among other suitable markup languages, object-oriented programming languages, scripting languages, style sheets, or other languages, protocols, frameworks, development kits, techniques or models, as well as content or resource locators used to identify and retrieve content from one or more locations internal or external to the database system 16.

As described above, in some implementations each user has a corresponding user profile in the database system 16. In addition to general information about the respective user (for example, name, title, phone number, photograph or avatar, biographical summary, status, among other information), each user profile also includes data defining the respective user's ability to interact with other information stored in the database system 16. In some implementations, a user profile can be characterized as a role-based access control container. In other words, a user profile can be considered as an abstract object that, among other data or information about a user, can define at least one role of the respective user (for example, a sales representative role). In turn, a user's role can inform (at least partially) what information the user has access to and the rights the user has with respect to that information. For example, as a profile can define a role, the set of permissions (or “permission set”) included in the profile can define the rights and access privileges associated with the tasks, functions, responsibilities or privileges associated with that role within the respective organization.

In some implementations, an administrator of (or for) an enterprise or other organization can define or be provided with various standard user profiles. Each of the standard (or “base” or “default”) user profiles can be considered a base object or structure of a particular user's user profile. In some implementations, when a user is added to the database system 16 for the first time the user is assigned one of a number of available standard user profiles. For example, such standard user profiles can include “sales representative,” “sales manager,” “services specialist,” “technical support analyst,” “engineer,” “marketing analyst,” or “revenue analyst,” among other possibilities that may be desired by, made available to, or defined by an organization.

In some implementations, each standard user profile includes a corresponding standard set of permissions enabled for a user assigned that standard user profile. As one non-limiting example, all users of an organization having the role of sales representative can be assigned a standard user profile associated with a sales role in the enterprise. Similarly, all users having the role of technical support analyst can be assigned a standard profile associated with a technical support role in the enterprise; all users having the role of marketing analyst can be assigned a standard profile associated with a marketing role in the enterprise; and all users having the role of software engineer can be assigned a standard profile associated with a software engineering role in the enterprise.

As described above, each user's user profile also generally includes other information about the user such as information about, identifying or otherwise associated with the user. In other words, while each user in the enterprise has a unique user profile, in some implementations each user's profile includes a standard (or “default”) set of permissions associated with a respective standard user profile assigned to the user. In this way, an administrator can grant an additional permission to, modify a permission of, or remove a permission from, all users assigned to a particular one of the standard user profiles simultaneously. That is, for example, by making a change to the default set of permissions included in or with that standard user profile, as opposed to granting, modifying or removing the permission on an individual user basis.

In some implementations, data or information about users (including users' respective user profiles) can be arranged in a layered, leveled or hierarchical (used interchangeably herein wherein appropriate) object structure in the database system 16. For example, a user profile can be considered one level of abstraction in such a layered data object. FIG. 5 shows a representation of an example of a layered data object 500 according to some implementations. As shown, a user profile 502 can be considered a data object that includes information 504 about the user (for example, in one or more lower level data objects or fields). In some implementations, the user profile 502 additionally includes a default set 506 of permissions enabled for the user (for example, as a permissions data object). By way of illustration, the default set 506 of permissions in FIG. 5 includes a first permission (“Perm A”), a second permission (“Perm B”) and a third permission (“Perm C”).

In some implementations, the default set of permissions (as well as the other sets of permissions described herein) can include one, two, ten, or virtually any other desired or required number of permission settings. In some implementations, each set of permissions can include one or more user permissions, object permissions, field permissions, class permissions, page permissions, service provider permissions, connected application permissions, application settings, tab settings, record type permissions, or other desired permission settings (all referred to collectively herein simply as “permissions”). In some implementations, one or more of the permissions are Boolean permissions, for example, in the sense that the permission for a particular feature is either enabled or not enabled.

In some implementations, each set of permissions can define, be assigned to, or otherwise be associated with one or more sets of presentation settings. In some implementations, each set of presentation settings defines the presentation (or “configuration”) of a UI provided for display to a user when requesting a data object of a particular data object type, such as a record of a particular record type. For example, in response to a request from a user to access, view or otherwise interact with a record, the application server 100 generates and provides for transmission and presentation to the user a UI displaying various UI elements. The UI elements can include various information about the record, reports, charts, links (for example, to other records, other users, contacts, or other content within or external to the database system 16), lists (for example, lists of other associated records such as cases for an account record), tasks, command buttons, fields, parameters, controls or other informative, interactive, adjustable or editable UI elements associated with the record (referred to collectively herein simply as “UI elements”).

In some implementations, the presentation settings for a record of a particular record type are defined by a page layout associated with the record type. In some implementations, each record is assigned one and only one record type, which, as described above, can be identified by a RecordTypeID associated with the record during the record's creation. The set of permissions associated with a particular user profile can determine which page layout is displayed in a UI when presenting each of the possible record types to the respective user. Because each record is assigned one record type, in some implementations, the page layout for a given record type for a particular user can be determined based on the default set of permissions associated with the user's profile (however, as described below, the page layout also can be determined based on another set of permissions associated with the user profile).

In some implementations, the presentation settings for a particular record type for a particular set of permissions are further defined based on which permissions are enabled in the set of permissions. For example, in some implementations, the page layout determines what UI elements can be displayed in the UI as well as the arrangement in which those UI elements are to be displayed; in other words, the “structure” of the page. Other permissions in the set of permissions determine which UI elements of the eligible UI elements made available by the page layout are actually displayed (for example, which UI elements are “enabled”), what functions or access controls the enabled UI elements provide to the user, or what information or other data is displayed in the enabled UI elements.

By way of illustration, for a record of a particular record type (for example, an account record), the page layout can determine which other record types are displayable in the UI (for example, cases, projects, and opportunities may be displayable while assets are not), as well as the arrangement of the various record types (for example, projects may be displayed above opportunities and cases may be displayed to the right of projects). However, in some implementations, other permissions in the set of permissions determine which UI elements are actually displayed to the particular user from the set of UI elements permitted by the page layout. For example, although a page layout is configured to show cases, if the permission to view cases, or a case of a particular type, is not granted in the default set of permissions associated with the user's standard user profile, then such cases are not displayed (unless, as described below, the permission(s) is/are included in one or more other sets of permissions associated with the user profile). As another example, while information about a record of a particular record type is displayed based on the set of permissions, the ability of the user to edit or delete the displayed information can be controlled by yet another permission (in the default or another set of permissions).

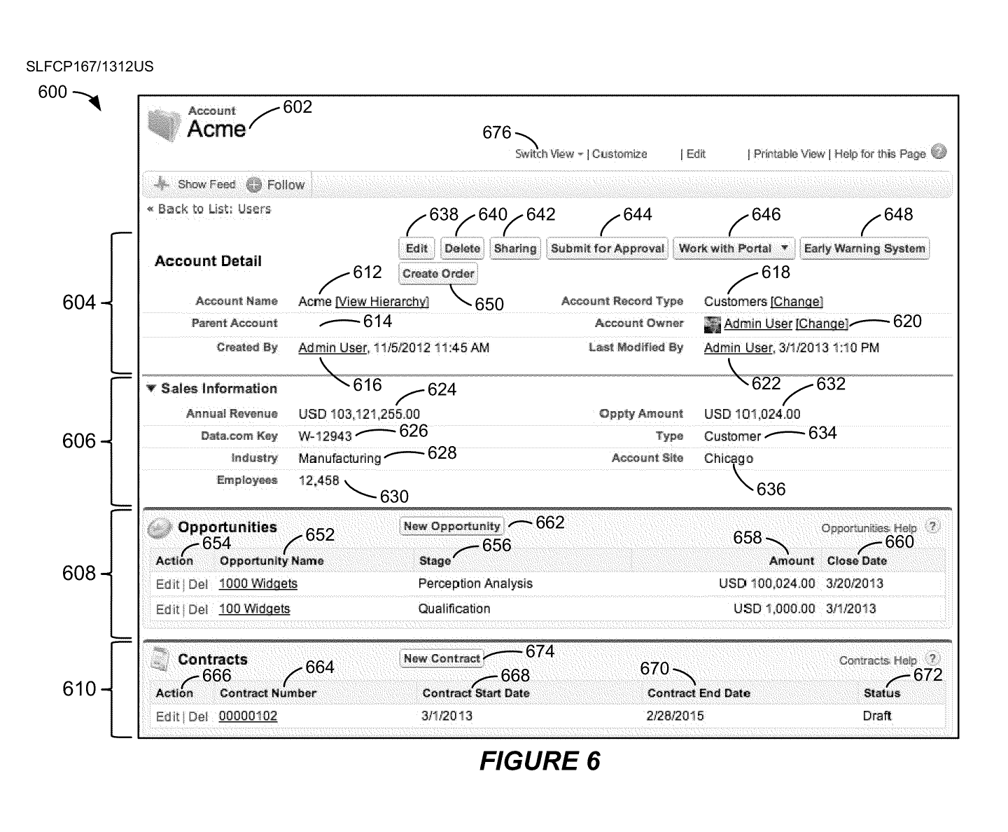

FIG. 6 shows an example of a UI 600 for an account record (a record of record type account) according to some implementations. The UI 600 can be defined, for example, by a page layout associated with a set of permissions for a sales representative role of the user. As such, the page layout for the UI 600 can be a sales-oriented or “sales” layout. To facilitate the sales representative role, the UI 600 can include information useful to the user for performing the role of sales representative. For example, the UI 600 includes the name (“Acme”) of the account in a location 602, an “Account Detail” section 604, a “Sales Information” section 606, an “Opportunities” section 608, and a “Contracts” section 610, each of which can be considered a UI element. In this example, the Account Detail section 604 also includes the name of the account in a location 612, a parent account (none in this example) in a location 614, a name or link to a user who created the account in a location 616, a record type of the account (Customers) in a location 618, a name or link to an account owner in a location 620, and a name or link to a user who last modified the account in a location 622. The Account Detail section 604 additionally includes control buttons for taking an action with respect to various information in the Account Detail section or the account in general. For example, the control buttons can include buttons 638, 640, 642, 644, 646, 648 and 650 for editing, deleting, sharing, submitting for approval, working with a portal (for example, an online support channel), submitting a warning, and creating an order, respectively.

The Sales Information section 606 can include the annual revenue of the account in a location 624, a key in a location 626 (for example, that identifies the record in the context of a particular product), an industry in a location 628, a number of employees in a location 630, an opportunity amount in a location 632, a type in a location 634, and an account site in a location 636. The Opportunities section 608 can include opportunities (each of which can be a record within the larger account record) for business with the account. For example, a column 652 can include names or links to opportunities (for example, a potential sale of 1000 widgets), a column 654 can include actions the user can take with respect to the opportunity in the same row (for example, edit or delete), a column 656 can include a stage the opportunity is in (for example, a stage of a process or work flow), a column 658 can include the value/amount of the opportunity, and a column 660 can include an actual or target close date. The Opportunities section 608 also can include a “New Opportunity” control button 662 for creating a new opportunity.

The Contracts section 610 can include names or links to contracts (each of which can be a record within the larger account record) with the account. For example, a column 664 can include name, numbers or links to contracts, a column 666 can include actions the user can take with respect to the contract in the same row (for example, edit or delete), a column 668 can include a start date of the contract, a column 670 can include an end date of the contract, and a column 672 can include a status of the contract. The Contracts section 610 also can include a “New Contract” control button 674 for creating a new opportunity. As described above, the arrangement of the UI elements including the sections 604, 606, 608 and 610, as well as the information, columns and control buttons within these sections, are determined by the sales layout.

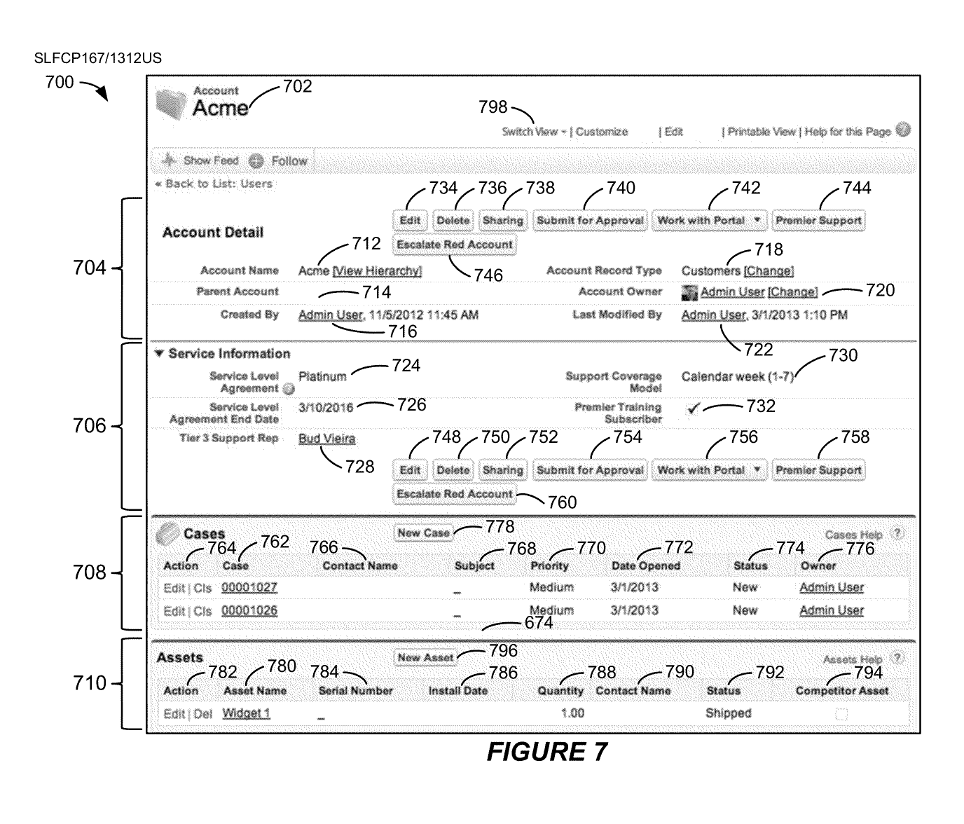

FIG. 7 shows a different example of a UI 700 for the account record of FIG. 6 according to some implementations. The UI 700 can be defined, for example, by a page layout associated with a set of permissions for a technical support or other services role of the user. As such, the page layout for the UI 600 can be a support- or service-oriented or “services” layout. To facilitate the support or services role, the UI 700 can include information useful to the user for supporting or providing one or more other services to the account. For example, the UI 700 also includes the name of the account in a location 702, an Account Detail section 704, a “Service Information” section 706, a “Cases” section 708, and an “Assets” section 710. In this example, the Account Detail section 704 also includes the name of the account in a location 712, a parent account (none in this example) in a location 714, a name or link to a user who created the account in a location 716, a record type of the account (Customers) in a location 718, a name or link to an account owner in a location 720, and a name or link to a user who last modified the account in a location 722.

The Account Detail section 704 additionally includes control buttons for taking an action with respect to various information in the Account Detail section or the account in general. For example, the control buttons can include some similar buttons to those in the UI 600, including buttons 734, 736, 738, 740, 742, and 744 for editing, deleting, sharing, submitting for approval, working with a portal, and submitting a warning, respectively. However, in the UI 700 an “Escalate Red Account” button 746 can be displayed instead of the “Create Order” button 650 displayed in the UI 600. For example, the Escalate Red Account button 746 can be used by the user to create an alert, escalate an alert, escalate a status, or escalate a priority of the account. Such an escalation may be deemed necessary, for example, when the organization associated with the account is experiencing a technical problem requiring technical support, is experiencing another problem requiring service, has made a complaint, has indicated dissatisfaction or is generally unhappy. As another example, such an escalation may be deemed necessary when the account is delinquent in payment, late in delivery of products, behind schedule on a business deal, in violation of a contract, in danger of pulling out of a deal or revoking an offer, or is otherwise requiring increased or special attention.

The Service Information section 706 can include a service level agreement (SLA) or SLA type/class associated with the account in a location 724, an SLA end date in a location 726, a designated support representative in a location 728, a type of support coverage in a location 730, and an indication of a type of subscriber in a location 732. The Service Information section 704 also includes control buttons for taking an action with respect to various information in the Service Information section or the account in general. For example, the control buttons can include some similar buttons to those in the Account Detail section 704, including buttons 748, 750, 752, 754, 756, 758 and 760 for editing, deleting, sharing, submitting for approval, working with a portal, submitting a warning and escalating the account, respectively.

The Cases section 708 can include cases (each of which can be a record within the larger account record). For example, each case can correspond to a problem or issue associated with the account that requires (or required) resolution or attention. For example, a column 762 can include the names, numbers or links associated with cases, a column 764 can include actions the user can take with respect to the case in the same row (for example, edit or delete), a column 766 can include a name or link to a contact associated with the case, a column 768 can include a subject of the case, a column 770 can include a priority associated with the case (for example, high, medium or low), a column 772 can include a date when the case was opened, a column 774 can include a status of the case (for example, new, open, resolved or closed), and a column 776 can include a name or link to an owner of the case. The Cases section 708 also can include a “New Case” control button 778 for creating a new opportunity.

The Assets section 710 can include assets (each of which can be a record within the larger account record). For example, each asset can correspond to a product sold to the account. For example, a column 780 can include the names, numbers or links associated with the assets, a column 782 can include actions the user can take with respect to the asset in the same row (for example, edit or delete), a column 784 can include a name or link to a serial number associated with the asset, a column 786 can include an installation date, a column 788 can include a quantity of the asset, a column 790 can include a contact name associated with the asset, a column 792 can include a status of the asset (for example, shipped, delivered, lost or returned), and a column 794 can indicate a competitor's product. The Assets section 710 also can include a “New Asset” control button 796 for adding a new asset (for example, a new product sold to the account).

As is evident, a UI can include a large amount and variety of information as well as enable a large number and variety of controls or actions. In some implementations, not all of the possible information and UI elements associated with a record is/are included in the UI displayed to all users. For example, it can be desirable to reduce or limit the information or UI elements that is/are displayed, editable, controllable or actionable by different users at different times to make the UI more relevant, useful, concise, efficient or aesthetically pleasing, or to limit or prevent the disclosure or altering of particular information by particular users or classes of users.

In some implementations, the page layout assigned to a particular user for a particular record type is primarily, generally, or at least partially based on the user's current needs or optimal set of prioritized responsibilities, assigned tasks, or other commitments with respect to the record type. For example, a user having a support or services role may benefit from a “services” layout, such as the UI 700 of FIG. 7, that provides access and controls associated with currently open or previous cases for an account, or to assets of the account. However, a user having a sales role may not need or desire such information or UI elements when displaying a UI for the same account record. Instead, the user having the sales role may benefit from a “sales” layout, such as the UI 600 of FIG. 6, that provides access and controls associated with current or previous opportunities, contracts, or orders for the same account record to facilitate the sales role. As described above, what information or UI elements is/are displayed and actionable can be further restricted or optimized based on the enabled permissions to further reduce or prevent the display of non-useful, irrelevant, sensitive or privileged information within a given page layout. However, while such tailored or optimized role-based presentations of information can be desirable, there are instances in which a single user desires or needs to perform multiple roles with respect to a given record or record type.

In some implementations, one or more additional (or “secondary”) sets of permissions can be layered over a user's profile. For example, in FIG. 5, a data object including a second set 508 of permissions is layered over the user profile 502, and a data object including a third set 510 of permissions is layered over the second set 508 of permissions. In some implementations, any desired number of different sets of permissions can be layered over a user profile. In some implementations, because some or all of the permissions can be additive, by adding (or “layering”) one or more additional sets of permissions over a single user profile, the user profile can be associated with virtually any number of sets of permissions in addition to the default set of permissions included in the user profile. For example, in some implementations, if a permission is enabled in the default set of permissions included in a user profile, but the same permission is not enabled (or “disabled”) in an overlying second set of permissions, the permission is still enabled for the user. Similarly, if a permission is not enabled in the default set of permissions, but the same permission is enabled in an overlying second set of permissions, then the permission is still enabled for the user. In other words, in some implementations, if a permission is enabled in at least one of the sets of permissions associated with a user profile, then the permission is enabled for the respective user. In some implementations, a permission is not enabled for a user when the permission is not enabled in any of the sets of permissions associated with the user profile.

In this way, the permissions included in the user's user profile (for example, the default set of permissions 506) can remain fixed or unchanged across users associated with a particular standard user profile, while the permissions granted to a particular one of the users at a particular time can be based on, for example, a current, new, temporary, or time-varying role, sub-role (within a larger role), set of duties, task, assignment, responsibility, or a combination of these (also referred to collectively herein as a “role”) associated with a particular record or record type. Additionally or alternatively, the permissions granted to a particular one of the users at a particular time can be based on the role of the user with respect to a record during a particular stage in a sales process, an investigatory process, a negotiation or contract process, a services process, a support process, or another suitable business or technical process.

As an example of one specific implementation or application, assume that a user's assigned standard user profile (and associated “standard” or “default” role) permits the viewing of particular information associated with a record of a particular record type. In such case, the user's default set of permissions can include an enabled read permission associated with the information. However, in some instances, an administrator may need or desire to grant the particular user the capability to edit or modify the information, but not grant this capability to other users assigned the same standard user profile. In such case, the administrator can expand the particular user's default role, or add an additional role, by layering a second set of one or more permissions over the user's user profile that includes an enabled “edit” permission associated with the information.

In other words, the user's default role can be expanded from that defined based on the assigned standard user profile to include the additional permissions needed by the user to fulfill the user's expanded role. Or in other terms, the user's default role can be said to remain unchanged, while the user can be assigned an additional or secondary role in addition to the user's default role. In this manner, each set of permissions can be associated with a different role or sub-role of the user. Additionally, in some implementations, each set of permissions can further define a role of the user with respect to records of different record types. In other words, a user's role in the context of accessing a record of a particular record type can be different than the role in the context of accessing a record of another record type. For example, a user having a default role of sales representative can be assigned a set of permissions that is associated with a project analyst role for partner accounts, and a sales role for customer accounts. As another example, a user having a default role of sales representative can be assigned a set of permissions that is associated with a technical support role for cases, and an investigatory role for opportunities.

Because any desired number of sets of permissions can be layered over a user's profile, each user profile can be associated with the permissions required by, or relevant to, one, two or more different roles or sub-roles (some of which can be temporarily authorized roles while others of which can be extended or permanent roles). While it can be useful or desirable for a user to have multiple sets of permissions enabling the user to perform multiple roles with respect to a given record or record type, it can be useful or desirable to limit what is displayed or actionable in a page layout of a UI for a given combination of record type and user (where the user is represented by all of the sets of permissions associated with the user's user profile). For example, because some or all of the permissions in the various sets of permissions can be additive, each set of permissions can increase the number of UI elements or amount of information displayable to the associated user, and thus, a user having multiple roles or sub-roles can be presented with a large amount of information or access controls that is/are irrelevant or not currently useful for a particular task of the user. As a more specific example, a user having a first set of permissions associated with a sales role, a second set of permissions associated with a technical support role, and a third set of permissions associated with a marketing role—all for a single record type—generally doesn't require all the information and UI elements useful for each of the different roles at any one point in time. That is, for a given task associated with a given record type, a user may need only the information or access controls associated with a single one of the user's roles. It can be useful to assign different page layouts to records based on record type to provide a streamlined user experience that enables the user to more easily, effectively or efficiently execute a particular task or fulfill a particular role at a particular time.

In some implementations, each set of permissions can include an assignment of a particular page layout for each possible record type. In some implementations, an administrator of (or for) the enterprise can define or assign the page layout assignments for each record type included in each set of permissions. The administrator also can define (for example, enable or disable) the object permissions and field permissions in each set of permissions. In some implementations, the administrator can assign page layouts to each of some or all of the possible record types for each set of permissions. However, each set of permissions is not required to include an assignment of a page layout for each possible record type; for example, each record type also can have a default page layout based on an organization—or system wide master setting for the record type. This ensures that there is at least one page layout for each combination of user and record type. In some implementations, record types for which a page layout is not assigned are displayed in a default layout. Additionally, some or all of the record types can be assigned the same page layout.

Because each set of permissions associated with a user profile (including the default set of permissions and the one or more additional secondary sets of permissions) can be associated with a different role of the user, the different sets of permissions associated with a single user profile can include page layout assignments that are different for a given record type. For example, a first set of permissions associated with a user profile can include an assignment of a sales layout for records of type “customers” while a second and a third set of permissions associated with the user profile can include an assignment of a services layout and a support layout for customers, respectively. In other words, while each set of permissions can include a single page layout for each record type, because any number of different sets of permissions can be associated with a single user profile, a single user profile can be simultaneously associated with sets of permissions having different page layout assignments for a given record type. Because a given record type and user combination can simultaneously include different page layouts for a given record type, a conflict can exist, for example, as to which page layout to display at a particular time.

Some implementations are particularly advantageous in such a context by providing a resolution to prevent a conflict. For example, some example implementations enable a user to select which layout is displayed when requesting a particular record type. For example, a user can select a sales layout, such as the UI 600 of FIG. 6, when the role of the user in the context of a given record and task is facilitated by a UI having a sales-oriented layout, and select a services layout, such as the UI 700 of FIG. 7, when the role of the user in the context of the same record but a different task is facilitated by a UI having a services-oriented layout. In some implementations, when a user requests a particular record from the database system 16, the application server 100 initially provides a UI for the record having the layout associated with the default set of permissions included in the user's profile. In some other implementations, when a user requests a particular record from the database system 16, the application server 100 initially provides a UI for the record having the layout that was last selected by the user for that record or record type. For example, in such implementations the database system 16 can track the last-selected layout for a particular combination of record type and user (or particular record and user) and provide the last-selected layout to the user the next time the user selects the record or another record of that record type.

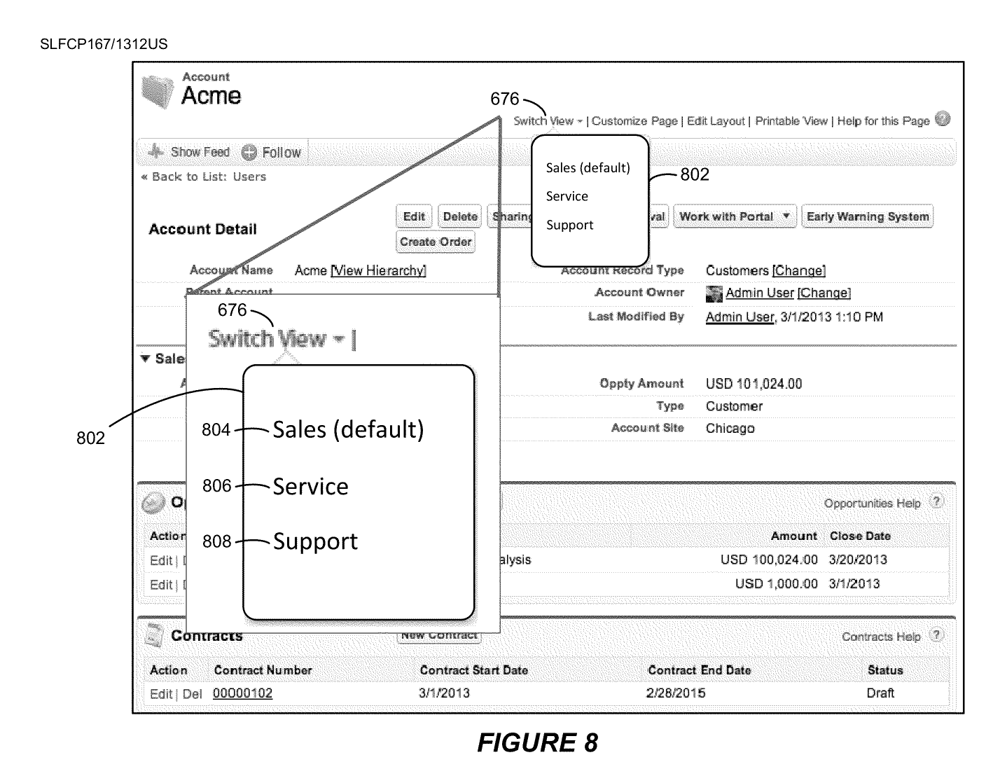

In some of these or other implementations, whichever layout is initially provided or currently displayed to a user can include a UI element (for example, a button, toggle switch or link) that when “clicked” or otherwise selected, enables the user to select a preferred layout for the UI. For example, the UIs 600 and 700 of FIGS. 6 and 7, respectively, show examples of a “Switch View” link or button 676 and 798, respectively, that enables the user to change the layout (and thus the presentation or view) of the record, for example, from the UI 600 to the UI 700, and vice versa. In some implementations, a user's selection of the Switch View UI element 676 or 798 can cause a picklist, drop-down menu, pop-up window, or other UI element to be displayed that enables the user to select the preferred layout. FIG. 8 shows the UI 600 of FIG. 6 with an expanded view of a page layout picklist 802 displayed after the selection of the Switch View UI element 676 according to some implementations. In this non-limiting example, the picklist 802 includes three selectable layouts 804, 806 and 808 for a Sales layout, a Service layout and a Support layout, respectively. Upon the clicking or selection of one of the available layouts in the picklist 802, the application server 100 generates and provides a UI having the selected layout. In some implementations, the picklist can indicate which of the available layouts is the default layout (the sales layout in the example shown in FIG. 8).

Thus, in some implementations, an administrator can control the subset of page layouts made available to a user for a given record type based on the page layout assignments the administrator includes in the sets of permissions associated with the user's profile. But in some such implementations, a user can control which layout of the subset of available layouts is provided for display at any given time, for example, by selecting an available layout from the picklist 802 based on a current role, sub-role or task of the user with respect to the record. In some implementations, the switch view UI element (for example, the switch view element 676 or 798 of FIGS. 6 and 7, respectively) is displayed only when more than one layout is available for the record based on the sets of permissions associated with the user's profile.

As described above, in some implementations, the database system 16 can track the layout last selected by the user when viewing a record. The database system 16 can provide the last-selected layout when the user, at a subsequent time, requests to view the record, or another record of the same record type. In some such implementations, whether the last-selected layout will be the configuration provided and displayed to the user the next time the user selects to view the record, also can be determined and set programmatically by an administrator. Additionally, the determination of whether to display the last-selected layout also can be different based on whether the subsequent request is made in the same authenticated session or in an authenticated session at some time in the future. More specifically, in some implementations, when a user requests access to the database system 16 (for example, by opening a web browser, web application, or other interface), the user must first be authenticated (“log in”) before the user has access to records in the database or is able to access various applications or services provided by the application server 100. In some such implementations, the database system 16 can provide a last-selected layout for a record when the request for the record is made in the same authenticated session as the last selection for the record or of another record of the same record type (that is, before the user logs out). In some other implementations, a user can be provided with the ability to determine whether the user's last-selected layout is provided for display the next time the user requests the record or another record of the same record type.

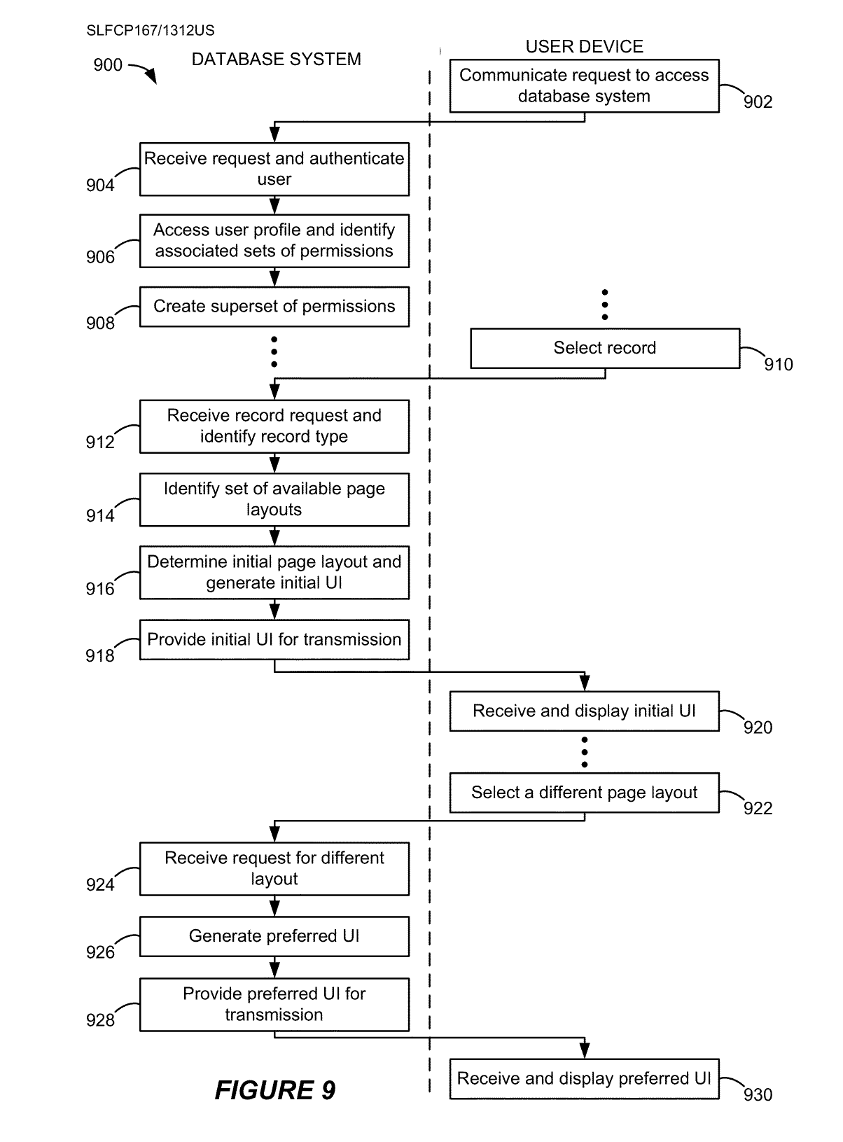

FIG. 9 shows a timing diagram illustrating an example of a computer-implemented process flow 900 for providing a UI for display to a user according to some implementations. The process flow 900 begins in block 902 when the user communicates a request to access the database system 16 (for example, a request to “log in” to the database system 16). The application server 100 receives the request and authenticates the user in block 904. After the application server 100 authenticates the user, the application server accesses the user profile associated with the user and identifies (or “retrieves”) the sets of permissions associated with the user profile in block 906. As described above, the user profile can include a default set of permissions as well as one or more additional sets of permissions. In block 908, the application server 100 creates a superset of permissions, for example, by constructively adding all of the permissions in all of the sets of permissions associated with the user profile identified in block 908. In some implementations, the application server 100 loads the combined set (or “superset”) of permissions created in block 910 into a temporary storage (or “cache”) for the duration of the user's authenticated session.

In block 910, the user selects a record or otherwise causes a request for the record to be communicated to the database system 16. In block 912, the application server 100 receives the request for the record and identifies the record type of the record. Based on the record type identified in block 912 and the sets of permissions identified in block 908, the application server 100 then identifies the set of available page layouts for the record in block 914. In block 916, the application server 100 determines an initial page layout for the record and generates (or retrieves) an initial UI for the record based on the initial page layout and the superset of permissions created in block 908. For example, in some implementations the application server 100 selects the page layout assigned in the default set of permissions as the initial page layout. In some other implementations, the application server 100 selects the page layout last selected by the user for the record or for another record of the same record type. In block 918, the application server 100 provides the initial UI for transmission to the user's computing device, which then receives and displays the UI in block 920.

Subsequently, in block 922, the user selects a different page layout or otherwise causes a request for the different page layout to be communicated to the database system 16. For example, the user can select the different page layout from a picklist of available page layouts, such as the picklist 802 shown in the UI 600 upon selecting a Switch View element 676. In block 924, the application server 100 receives the request for the different page layout. In some implementations, the application server 100 then determines whether the requested page layout is included in the available sets of page layouts identified in block 916. However, this determination may not be included, for example, in some other implementations in which the user can select page layouts only from page layouts already determined to be available. For example, the Switch View elements 676 or 798 described above may, in some implementations, be displayed only when the application server 100 has determined that more than one page layout is available for the record in block 914. Thus, in such implementations, if the user is requesting a different page layout, the determination has already been made that the user is authorized to view the page layout.

The application server 100 then generates, in block 926, a UI having the desired or preferred page layout selected by the user in block 922 and the superset of permissions created in block 908. In block 928, the application server 100 provides the desired UI for transmission to the user's computing device, which then receives and displays the UI in block 930. As described above, the application server 100 may then store the selection made by the user in block 922 for use in determining an initial page layout for displaying the record or another record of the same type at a subsequent time.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system storing:
a plurality of data objects, and
a plurality of user profiles, each user profile corresponding to a respective user; and
one or more processors operable to:
receive a first request for a data object from a device associated with a user, the user having a corresponding user profile in the database system,
identify one or more available user interface (UI) configurations based on the user profile and on the data object,
communicate first information to the user device, the first information configured to be processed by a processor of the user device to display a UI having a first one of the available UI configurations,
receive a second request to change the UI to have a second one of the available UI configurations, and
communicate second information to the user device, the second information configured to be processed by the processor of the user device to display the UI having the second UI configuration.

2. The system of claim 1, wherein each user profile is associated with one or more sets of one or more permissions, the one or more processors being further operable to, responsive to receiving the first request:
access the user profile corresponding to the user; and
identify the permission sets associated with the user profile.

3. The system of claim 2, wherein:
the first UI configuration is associated with a first permission set associated with the user profile; and
the second UI configuration is associated with a second permission set associated with the user profile.

4. The system of claim 3, the one or more processors being further operable to:
identify an object type of the data object;
identify one or more of the available UI configurations based on the object type and the one or more permission sets associated with the user profile;
assign the first UI configuration a first layout based on the object type and the first permission set; and
assign the second UI configuration a second layout based on the object type and the second permission set.

5. The system of claim 3, the one or more processors being further operable to, responsive to receiving the second request, determine whether the user is authorized to view the second UI configuration based on the permission sets associated with the user profile, including determining whether the user profile is associated with the second permission set.

6. The system of claim 3, the one or more processors being further operable to:
receive a temporary authorization for the user; and
update the database system to associate the user profile with the second permission set responsive to receiving the temporary authorization.

7. The system of claim 2, the one or more processors being further operable to generate a superset of combined permissions based on the identified permission set.

8. The system of claim 7, the one or more processors being further operable to apply the superset of permissions to generate the first or the second UI configuration.

9. The system of claim 1, wherein:
the first UI configuration includes a first plurality of UI elements; and
the second UI configuration includes a second plurality of UI elements including at least one UI element different than each of the UI elements in the first UI configuration.

10. The system of claim 1, wherein the first UI configuration facilitates a first role of the user with respect to the data object and the second UI configuration facilitates a second role of the user with respect to the data object.

11. The system of claim 1, wherein the first UI configuration is a default configuration for the data object or an object type associated with the data object.

12. The system of claim 11, wherein the first permission set is a default permission set included in the user profile.

13. The system of claim 11, wherein the default configuration is associated with a last-selected one of the available UI configurations for the data object or an object type associated with the data object.

14. The system of claim 1, wherein the second request to change the UI to have the second UI configuration is originated responsive to the user selecting a UI element from the UI having the first UI configuration.

15. A computer-implemented method comprising:
receiving, by a database system that stores a plurality of data objects and a plurality of user profiles, a first request for a data object from a device associated with a user, the user having a corresponding user profile in the database system;
identifying one or more available user interface (UI) configurations based on the user profile and on the data object;
communicating first information to the user device, the first information configured to be processed by a processor of the user device to display a UI having a first one of the available UI configurations;
receiving a second request to change the UI to have a second one of the available UI configurations; and
communicating second information to the user device, the second information configured to be processed by the processor of the user device to display the UI having the second UI configuration.

16. The method of claim 15, wherein each user profile is associated with one or more sets of one or more permissions, and wherein the method further includes, responsive to receiving the first request:
accessing the user profile corresponding to the user; and
identifying the permission sets associated with the user profile.

17. The method of claim 16, wherein
the first UI configuration is associated with a first permission set associated with the user profile; and
the second UI configuration is associated with a second permission set associated with the user profile.

18. The method of claim 17, the method further including:
identifying an object type of the data object;
identifying one or more of the available UI configurations based on the object type and the one or more permission sets associated with the user profile;
assigning the first UI configuration a first layout based on the object type and the first permission set; and
assigning the second UI configuration a second layout based on the object type and the second permission set.

19. The method of claim 17, the method further including:
receiving a temporary authorization for the user; and
updating the database system to associate the user profile with the second permission set responsive to receiving the temporary authorization.

20. A non-transitory computer-readable storage medium storing instructions executable by one or more processors to cause operations to be performed including:
receiving, by a database system that stores a plurality of data objects and a plurality of user profiles, a first request for a data object from a device associated with a user, the user having a corresponding user profile in the database system;
identifying one or more available user interface (UI) configurations based on the user profile and on the data object;
communicating first information to the user device, the first information configured to be processed by a processor of the user device to display a UI having a first one of the available UI configurations;
receiving a second request to change the UI to have a second one of the available UI configurations; and
communicating second information to the user device, the second information configured to be processed by the processor of the user device to display the UI having the second UI configuration.
